(19) United States
(12) Patent Application Publication
(10) Pub. No.: US 2016/0034019 A1
(43) Pub. Date: Feb. 4, 2016

(54) DISPLAY APPARATUS AND CONTROL METHOD FOR CONTROLLING POWER CONSUMPTION THEREOF

(71) Applicant: SAMSUNG ELECTRONICS CO., LTD., Suwon-si (KR)

(72) Inventors: Young-kwang SEO, Suwon-si (KR); Yong-jun PARK, Seoul (KR); Dae-woo CHO, Yongin-si (KR); Sang-on CHOI, Suwon-si (KR)

(73) Assignee: SAMSUNG ELECTRONICS CO., LTD., Suwon-si (KR)

(21) Appl. No.: 14/798,641

(22) Filed: Jul. 14, 2015

(30) Foreign Application Priority Data
Jul. 30, 2014 (KR) 10-2014-0097077

(51) Int. Cl. G06F 1/32; G06K 9/00; G09G 3/20; H04N 5/63

(52) U.S. Cl. CPC G06F 1/3265; H04N 5/63; G06F 1/3231; G06K 9/00369; G09G 3/2003; G09G 2330/021; G09G 2320/0626

(57) ABSTRACT

A display apparatus is provided. The display apparatus includes a display configured to display an image; an image sensor configured to photograph a front view area of the display apparatus; and a controller having a plurality of image processing modes, each image processing mode having a power consumption level that is different than a power consumption level of other image processing modes of the plurality of image processing modes, and configured to process the photographed image in an image processing mode which consumes less power than a normal mode, and control the display to display the image in the normal mode if it is determined based on results of the processing of the photographed image that a user is present in the front view area of the display apparatus.

### CROSS-REFERENCE TO RELATED APPLICATION

This application claims priority from Korean Patent Application No. 10-2014-0097077, filed on Jul. 30, 2014 in the Korean Intellectual Property Office, the disclosure of which is incorporated herein by reference in its entirety.

### BACKGROUND

1. Field

Apparatuses and methods consistent with the exemplary embodiments relate to a display apparatus and a control method thereof, and more particularly to a display apparatus and a control method thereof, which detects the presence of a user in front of a display and decreases power consumed in displaying an image based on whether a user is detected in front of the display.

2. Description of the Related Art

A television (TV) or similar electronic device which has a large screen consumes a relatively large amount of power in the display section of the device. In particular, if a TV has a function of sensing a user through a webcam, the TV is always kept in a turned-on position regardless of whether a user is present in the front view area of the display, thereby unnecessarily increasing the level of power consumption.

Accordingly, there is a need to decrease the power consumed in a display itself when it is sensed that a user is not positioned in front of the display.

A TV employing a webcam to sense the presence of a user can sense a motion of the user moving toward the front of the display, but cannot sense a user's presence if the user remains motionless while in front of the display, or if the user moves out of the front view area of the display after being positioned in front of the display.

### SUMMARY

One or more exemplary embodiments provide a display apparatus which minimizes power consumption of the display when an image sensor does not sense a user's presence in the front view area of the display.

One or more exemplary embodiments also provide a display apparatus which senses the presence of a user when the user remains in a motionless state after being sensed, or when the user leaves the front view area of the display apparatus after being sensed.

In accordance with an aspect of an exemplary embodiment, there is provided a display apparatus including: a display configured to display an image; an image sensor configured to sense an image captured by photographing an external area of the display apparatus; and a controller having a plurality of image processing modes, each image processing mode of the plurality of image processing modes having a different power consumption level that is different than a power consumption level of other image processing modes of the plurality of image processing modes, the controller being configured to, in a power saving mode, process the photographed image in an image processing mode, which consumes less power than a normal mode, among the plurality of image processing modes and in response to determining, based on a result of the processing the photographed image, that the photographed image indicates a presence of a user in the front view area of the display apparatus, control the display to display the image in the normal mode.

The plurality of image processing modes are different from each other by at least one of a number of pixels of the photographed image to be processed or frames of the image to be processed, a resolution of the photographed image and an operation frequency.

The controller is configured to process some pixels among all pixels of the photographed image in a power saving mode. Thus, if a user is not detected, the number of pixels to be scanned for processing the photographed image is minimized to thereby decrease power consumption.

The controller may be configured to process some frames among all frames of the image in the power saving mode. Thus, if a user is not detected, power consumption is decreased by lowering a frame rate for processing an image.

The controller is configured to, in the power saving mode, process a displayed image to have a resolution lower than the resolution of the normal mode. Thus, if a user is not detected, power consumption is decreased by processing a displayed image at a low resolution.

The controller is configured to determine a processing target area, in which there is motion, among the entire area of the image to be processed. Thus, power consumption is decreased by selecting only an area, where there is motion, when an image is processed for detecting presence of a user.

The controller is configured to determine the processing target area based on a difference in brightness of all pixels between first and second frames of the photographed image. Thus, power consumption is decreased by selecting only an area, where brightness of the pixels is largely varied between a previous frame and a current frame, when an image is processed for detecting the presence of a user.

The controller is configured to determine the processing target area based on a difference in brightness of pixels in units of columns between a first frame and a second frame of the photographed image. Thus, power consumption is decreased by selecting only an area where brightness of pixels in units of frames is largely varied between a previous frame and a current frame, in consideration that a human has a feature of a vertically long silhouette, when an image is processed for detecting the presence of a user.

The controller is configured to determine whether a user is present within the processing target area, based on shapes of the processing target area. The presence of the user is detected by extracting at least one of a face of a user, an entire body of the user or a similar shape with respect to an area, in which there is motion, in an image.

The controller is configured to enter the power saving mode if a user is not present within the processing target area. Thus, the display apparatus enters the power saving mode, in which power consumption is minimized, if it is determined that a user is not present within a processing target area.

In accordance with an aspect of another exemplary embodiment, there is provided a display apparatus including: a display configured to display an image; an interface configured to connect the display apparatus with a detachable image sensor, and receive, from the image sensor, a photographed image of a front view area of the display apparatus, and output from the image sensor; and a controller having a plurality of image processing modes, each image processing mode of the plurality of image processing modes having a different power consumption level that is different than a power consumption level of other image processing modes of the plurality of image processing modes, the controller being configured to, in a power saving mode, process the photographed image in a selected power saving image processing mode, which consumes less power than a normal mode, among the plurality of image processing modes and in response to determining, based on a result of the processing the photographed image, that the photographed image indicates a presence of a user in the front view area of the display apparatus, control the display to display the image in the normal mode. Thus, the power consumption is minimized if a user is not detected while a camera connected through a universal serial bus (USB) cable is used to detect the presence of a user.

The interface may be configured to output a sensing signal for transmitting an image photographed by the image sensor, and the controller is configured to perform control to receive the photographed image in response to the sensing signal output from the interface. Thus, while the camera connected through the USB cable is used to detect the presence of a user, a sensing signal is transmitted to the display apparatus through a power supplying interface provided in the USB cable without any separate signal line for transmitting the sensing signal.

In accordance with an aspect of another exemplary embodiment, there is provided a method of controlling a display apparatus, the method including: outputting a photographed image of an a front view area of the display apparatus; in a power saving mode, processing the photographed image in a image processing mode, which consumes less power than a normal mode, among a plurality of image processing modes, each image processing mode of the plurality of image processing modes having a power consumption level that is different than a power consumption level of other image processing modes of the plurality of image processing modes; and controlling the display to display an image in the normal mode in response to determining, based on a result of the processing the photographed image, that the photographed image indicates a presence of a user in the front view area of the display apparatus.

The plurality of image processing modes is different from each other in at least one of the number of pixels or frames of the image to be processed, a resolution of the image to be processed, and an operation frequency.

The processing the photographed image may include processing some pixels among all pixels of the image in the power saving mode.

The processing the photographed image may include processing some frames among the whole frames of the image in the power saving mode.

The processing the photographed image may include processing, in the power saving mode, an image to have a resolution lower than a resolution of the normal mode.

The processing the photographed image may include determining a processing target area, in which motion is detected, among the whole area of the image to be processed.

The method may further include determining the processing target area based on a difference in brightness of the pixels between first and second frames of the image.

The method may further include determining the processing target area based on a difference in brightness of pixels in units of columns between first and second frames of the image.

The method may further include determining whether a user is present within the processing target area, based on shapes of the processing target area.

The method may further include entering the power saving mode if a user is not detected to be present within the processing target area.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram showing a display apparatus according to an exemplary embodiment;

FIG. 2 is a view showing an example of a display apparatus with a vision image sensor (VIS) according to an exemplary embodiment;

FIG. 3 is a view showing an example of switching an operation mode of a display apparatus according to an exemplary embodiment;

FIG. 4 is a view showing an example of switching from a quasi-standby mode to an informative display mode when a user is sensed, according to an exemplary embodiment;

FIG. 5 is a view showing an example of switching from the informative display mode to the quasi-standby mode when it is sensed that a user leaves the front view area of the display apparatus, according to an exemplary embodiment;

FIG. 6 is a block diagram showing a display apparatus with a detachable image sensor, according to an exemplary embodiment;

FIG. 7 is a view showing an example of a circuit for transmitting a sensing trigger signal from the image sensor to the display apparatus through a power interface according to an exemplary embodiment; and

FIG. 8 is a flowchart showing a control method of a display apparatus according to an exemplary embodiment.

### DETAILED DESCRIPTION OF EXEMPLARY EMBODIMENTS

Hereinafter, exemplary embodiments will be described in detail with reference to accompanying drawings so as to be easily realized by a person having an ordinary skill in the art, but not limited to the following exemplary embodiments set forth herein. Descriptions about unrelated parts are omitted for clarity, and like numbers refer to like elements throughout.

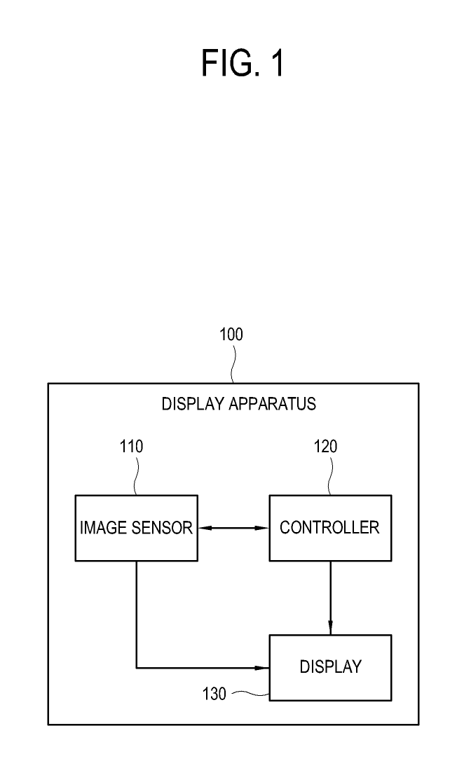

Hereinafter, elements of a display apparatus according to exemplary embodiments will be first described in detail with reference to FIG. 1. FIG. 1 is a block diagram showing a display apparatus according to an exemplary embodiment. As shown in FIG. 1, the display apparatus 100 includes an image sensor 110, a controller 120, and a display 130. For example, the display apparatus 100 may be achieved by a television (TV). However, the display apparatus is not limited thereto. The display apparatus may be embodied, for example, as a personal computer (PC), or a laptop computer. The display apparatus 100 outputs an image photographed by the image sensor 110 of an external area of the display apparatus 100 in a power saving mode. The display apparatus 100 processes the photographed image in an image processing mode, which consumes less power than the power consumed in a normal display mode, among a plurality of image processing modes of different levels of power consumption. The display apparatus 100 controls the display 130 to display an image in a normal mode, if it is determined, based on a result of processing the photographed image, that the photographed image indicates the presence of a user in the front view area of the display apparatus.

In such a display apparatus 100 according to an exemplary embodiment, the image sensor is configured to sense the presence of a user, so that power consumption can be minimized if the user is not detected. Further, it is possible to sense the presence of a user even when a user remains motionless while in the front view area of the display apparatus or when the user leaves the front view area of the display apparatus after being detected if a voice of the user is captured in the vicinity of the display apparatus.

The image sensor 110 outputs an image captured by photographing an external area of the display apparatus 100. The image sensor 110 has an optical structure of lenses, and may for example be achieved by a complementary metal oxide semiconductor (CMOS) image sensor (CIS), a charge-coupled device (CCD) image sensor, a heat detector, etc. Alternatively, the image sensor 110 may be achieved by a depth camera, or may be combined with an infrared (IR) source. The image sensor 110 may operate with respect to the whole pixels or only some pixels in accordance with present conditions.

The display 130 may display an image.

The controller 120 has a plurality of image processing modes each of which has a different level of power consumption, based on an image photographed by the image sensor 110. The plurality of image processing modes may be differentiated from each another in at least one among the number of pixels or frames of an image to be processed, a resolution of the display image to be processed, and an operation frequency. In a power saving mode, such as a first standby mode, a second standby mode (a quasi-standby mode, and an informative display mode, the controller 120 processes an image photographed in an image processing mode where power consumption is lower than the power consumption of a normal mode. According to an exemplary embodiment, the controller 120 can process a predetermined number of pixels among the whole pixels of the display image in the power saving mode. For example, in the power saving mode, the image sensor of 8 Mega pixels activates only 120*100 pixels among the whole pixels to operate with low power. In this case, the image sensor consumes power of 10 mW, and the whole TV consumes power of only 100 mW to 150 mW, thereby remarkably lowering the power consumption as compared with the power consumption in the normal mode.

According to another exemplary embodiment, in the power saving mode, the controller 120 processes a certain number of frames among the whole frames of an image. Alternatively, in the power saving mode, the controller 120 may process a displayed image to have a resolution lower than a resolution of the display image in the normal mode. Thus, the display apparatus 100 according to an exemplary embodiment may use various image processing methods to minimize the power consumption based on the processing an image photographed by the image sensor 110.

The controller 120 determines a processing target area, where motion is detected, within the whole area of a photographed image to be processed. The controller 120 may determine the processing target area, based on a difference in the brightness of the whole pixels between first and second frames of an image. Alternatively, the controller 120 may determine a processing target area, based on a difference in the brightness of pixels in units of columns between first and second frames of a photographed image. For instance, the processing target area is determined if an absolute value of a difference in brightness between different frames of pixels added in units of columns is equal to or greater than a predetermined value, and it is thus sensed that a user makes a motion. The controller 120 may determine the presence of a user within a processing target area, based on the shape of the processing target area. For example, the presence of a user may be detected by extracting at least one among a silhouette, a shadow shape, a face and an entire body area of the user with regard to the processing target area.

The controller 120 controls the display 130 to display an image in the normal mode, if it is determined based on a result of the processing of the photographed image that the photographed image detects the presence of a user.

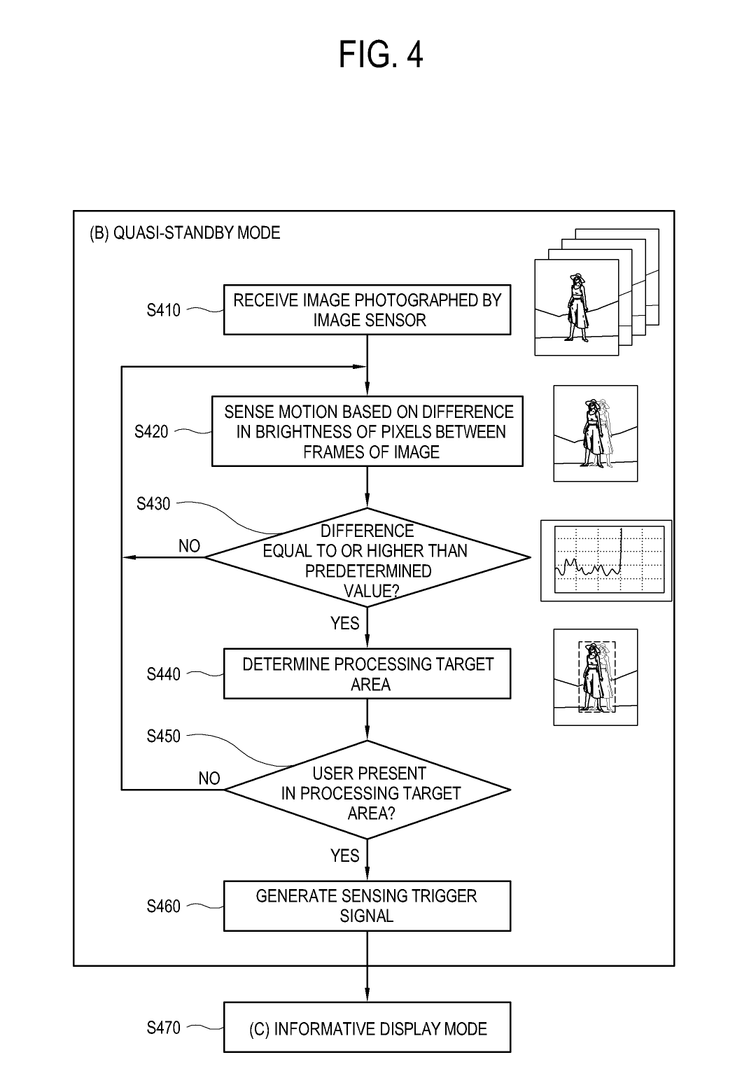

According to an exemplary embodiment, if a result of processing of the photographed image shows that the presence of a user is detected within the processing target area, the image is displayed in a normal mode. For instance, as shown in FIG. 4, in (B) a quasi-standby mode, a processing target area having motion is determined based on a difference in brightness of pixels between frames of an image photographed by an image sensor (S420, S430 and S440), and a user present within the processing target area is detected (S450 and S460), thereby entering (C) an informative display mode (S470).

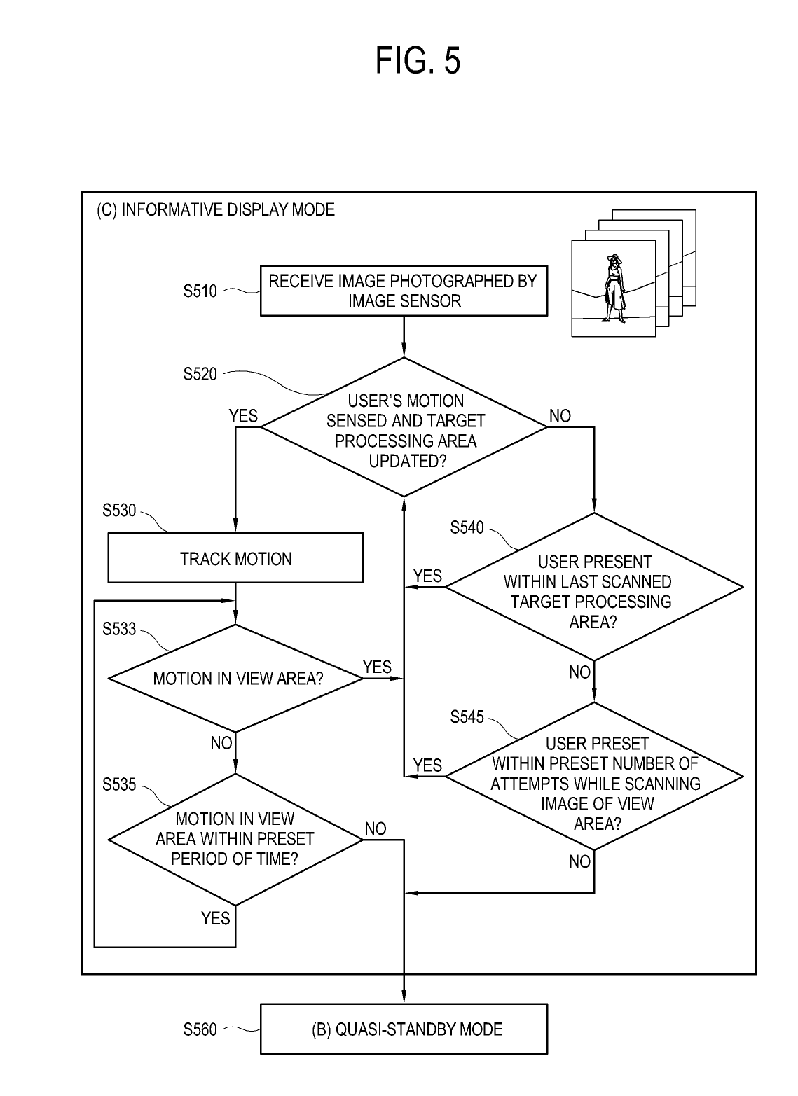

The controller 120 enters the power saving mode if it is determined that a user is not present within the processing target area. That is, if a user who is detected within the processing target area moves out of the processing target area, the movement of the user out of the processing target area is sensed, and the normal mode is switched into the power saving mode. For instance, as shown in FIG. 5, in (C) the informative display mode, motion is tracked within an image photographed by the image sensor (S530). If no motion is detected within a preset period of time (S535), the controller 120 enters (B) the quasi-standby mode (S560). The processing target area is scanned (S540). If presence of a user is not detected within a preset number of scanning attempts of the processing target area (S545), the controller 120 enters (B) the quasi-standby mode (S560).

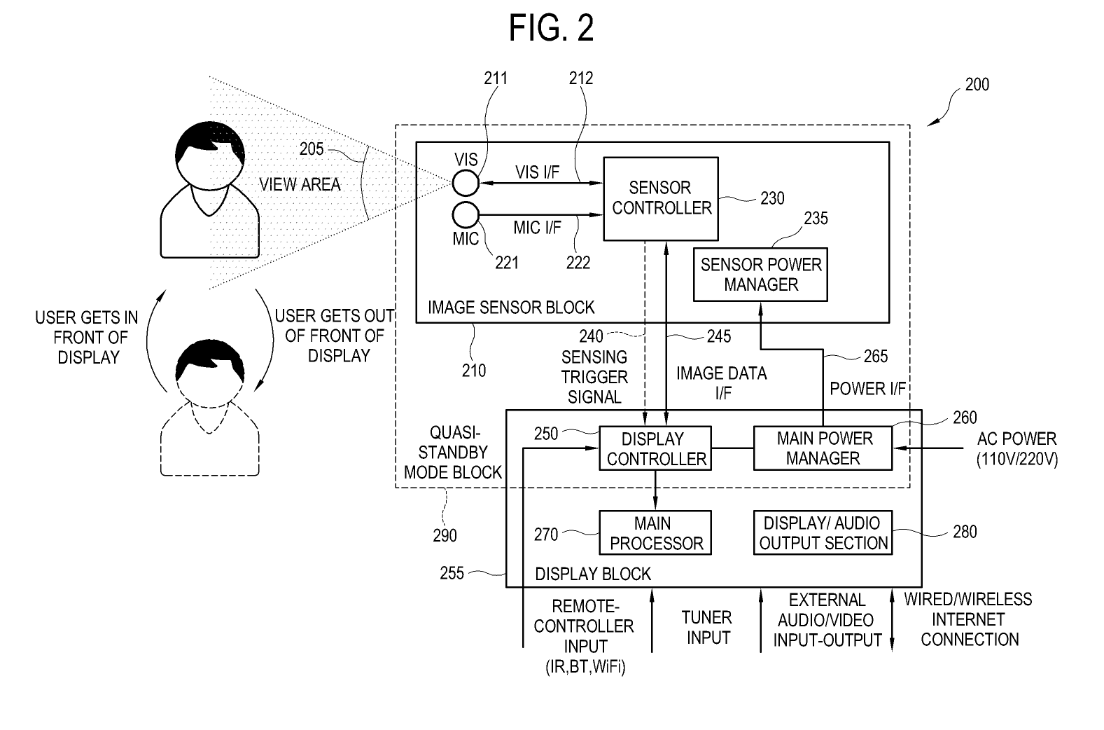

FIG. 2 is a view showing an example of a display apparatus with a vision image sensor (VIS) according to an exemplary embodiment. As shown in FIG. 2, a display apparatus 200 includes an image sensor block 210, and a display block 255. The image sensor block 210 includes a vision image sensor (VIS) 211, a microphone (MIC) 221, a sensor controller 230, a sensor power manager 235. The display block 255 includes a display controller 250, a main power manager 260, a main processor 270 and a display/audio output section 280. The VIS 211 and the MIC 221 correspond to the image sensor 110 among the elements of FIG. 1. Further, the sensor controller 230, the display controller 250 and the main processor 270 correspond to a portion of the controller 120 among the elements of FIG. 1. In addition, the display/audio output section 280 corresponds to the display 130 among the elements of FIG. 1.

The VIS 211 is an image sensor for detecting motion within a front view area 205 of the display apparatus 200. The VIS 211 may for example, be achieved by a CMOS image sensor (CIS), a CCD image sensor, a heat detector, etc. Alternatively, the image sensor 110 may be achieved by a depth camera, or may be combined with an infrared (IR) source. The VIS 211 may operate with respect to the whole pixels or only some pixels in accordance with the present conditions.

A VIS interface (I/F) 212 is an interface to which the sensor controller 230 is connected for controlling the VIS 211. Through the VIS I/F 212, an output signal of an image photographed by the VIS 211 is transmitted, and digital signals of inter integrated circuit (I2C), serial peripheral interface (SPI), universal asynchronous receiver transmitter (UART) or the like, an analog video output signal, etc. may be transmitted.

The MIC 221 may be achieved by a microphone to receive an audio sound from the exterior of the display apparatus.

An MIC I/F 222 may be an interface to which the second controller 230 is connected for controlling the MIC 221. Through the MIC I/F 222, audio data having analog and digital formats output from the MIC 221 may be transmitted.

The sensor controller 230 has an image signal processing (ISP) function of a related art camera, and also has processing functions of applying for example, scaling, cropping, zooming, compression, etc. to an output signal of a view area 205 photographed by the VIS 211. The sensor controller 230 transmits the output signal of the image photographed by the VIS 211 to the display block 255, and analyzes the image output signal of successive frames, thereby determining whether there is motion in the photographed image. Further, the sensor controller 230 may have a function of determining whether motion in an image area is caused by a human, and such a function may be performed, not by the sensor controller 230, but by the main processor 270. According to an exemplary embodiment, the sensor controller 230 may more clearly determine whether motion is detected in the photographed image by setting a noise level due to ambient brightness, a change in brightness, etc.

According to another exemplary embodiment, a function of tracking motion or tracking a human who makes motion in the image output signal may be provided, and such a function may be performed, not by the sensor controller 230, but by the main processor 270. The sensor controller 230 may include a memory in which a buffer, firmware, an algorithm, other registration information, etc. are stored and executed.

The sensor power manager 235 receives power from the main power manager 260, and converts the received power into a plurality of voltage levels respectively needed for the VIS 211, the MIC 221, the sensor controller 230, etc., thereby supplying the power. The sensor power manager 235 may receive power from a battery, an external power source, etc. instead of the main power manager 260.

The sensing trigger signal 240, which is a digital signal informing whether a user is detected in the front view area 205 of the display apparatus 200, is transmitted to the display block 255. The sensing trigger signal 240, which is a general purpose input output (GPIO) signal, may be transmitted through an interface physically separated from an image data I/F 245, or may alternatively be transmitted using the same interface as the image data I/F 245.

According to still another exemplary embodiment, the sensing trigger signal 240 may be transmitted using a power I/F 265. The sensing trigger signal 240 may be achieved by a wireless signal for Wi-Fi, Bluetooth, Zigbee, etc. as well as a wired signal.

The image data I/F 245 is an interface through which data output from the VIC 211 and the MIC 221 can be transmitted to the display controller 250, and may include a universal serial bus (USB), a universal asynchronous receiver transmitter (UART), a serial peripheral interface (SPI), Wifi, Bluetooth (BT), Zigbee, etc.

The power I/F 265 is a power supply interface for connecting the main power manager 260 and the sensor power manager 235, and supplies a single voltage or a plurality of voltages.

The display controller 250 receives and analyzes a remote-controller input, a sensing trigger signal 240, etc., thereby controlling operations of the display block 255. The display controller 250 may use a separate reset signal interface (not shown) or the power I/F 265 in order to reset the image sensor block 210.

The main power manager 260 may receive external power and convert the received external power into alternating current (AC)/direct current (DC) voltages needed for the display block 255 and the image sensor block 210.

The main processor 270 receives and analyzes an image of the view area 205 photographed by the VIS 211, thereby determining whether there motion is detected in the view area 205. According to an exemplary embodiment, the main processor 270 may implement an algorithm for determining the presence of a user and an algorithm for tracking the user. According to another exemplary embodiment, the main processor 270 may implement an algorithm for determining when a user moves into the front view area 205 of the display apparatus 200. In this case, the display/audio output section 280 may be controlled to display an image and output sound in accordance with the determined users.

A quasi-standby mode block 290 operates only the display controller 250 to receive a signal for activating the display block 255 in response to the sensing trigger signal 240, the remote-controller input, etc., so that the display block 255 can consume the minimum power. At this time, the main processor 270 and the display/audio output section 280 enters a sleep or inactivated mode. Further, the quasi-standby mode block 290 may make the image sensor block 210 consume the minimum power by decreasing a frame rate, using only a predetermined number of pixels, and lowering an operation frequency with respect to an image photographed by the VIS 211.

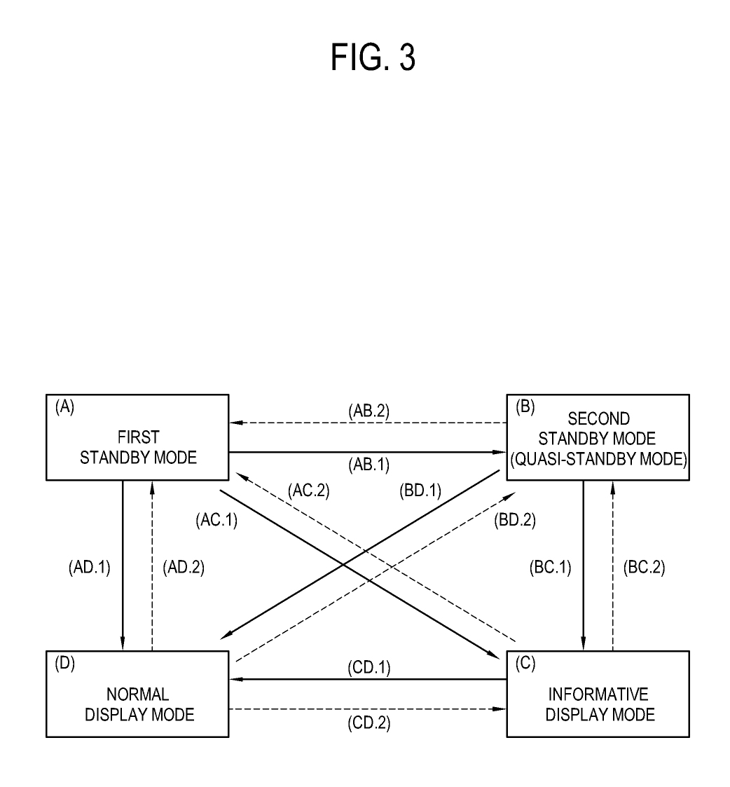

FIG. 3 is a view showing an example of switching an operation mode of a display apparatus according to an exemplary embodiment. As shown in FIG. 3, the display apparatus may operate in one among (A) a first standby mode, (B) a second standby mode (i.e. a quasi-standby mode), (C) an informative display mode and (D) a normal display mode, and switches between the operation modes in accordance with operation conditions.

In (A) the first standby mode, the image sensor block 210 of FIG. 2 does not operate and only the display controller 250 of the display block 255 operates. The first standby mode refers to a state that the whole display block 255 can be activated in response to the remote-controller input. In (A) the first standby mode, the minimum power is consumed, but the image sensor block 210 does not operate to detect a user.

In (B) the second standby mode (i.e. the quasi-standby mode), only the display controller 250 of the display block 255 in FIG. 2 operates similar to (A) the first standby mode, but the image sensor block 210 operates to detect the presence of a user within the front view area 205 of the display apparatus 200. At this time, the image sensor block 210 implements an algorithm for detecting motion and an algorithm for determining whether the motion is caused by a user. If a user is detected, the display apparatus enters (C) the informative display mode.

In (C) the informative display mode, the display/audio output section 280 operates if the image sensor block 210 senses the presence of a user within the front view area 205 of the display apparatus 200. At this time, in accordance with given information, the display/audio output section 280 may implement the whole operations or partial operations. For instance, in the case of a liquid crystal display (LCD) panel, a backlight unit may be locally used so as to reduce power consumption. Alternatively, if a user is detected, weather, a memo, a screen saver or a similar image may be automatically displayed. At this time, general contents may be displayed without determining who a user is, or alternately contents or an application customized to a specific user may be displayed by determining who the user is.

In (C) the informative display mode, a user may be tracked so as to determine whether the user is continuously positioned in front of the display apparatus. The algorithm for tracking a user may be implemented in the sensor controller 230 or the main processor 270 of FIG. 2. In (C) the informative display mode, if a user moves from the front view area 205 of the display apparatus 200 and does not return to the front view area within a preset period of time, the display apparatus 200 may enter (B) the quasi-standby mode. According to another exemplary embodiment, if the MIC 221 receives a voice input even through a user moves from the view area 205, the display apparatus 200 may determine whether to enter (B) the quasi-standby mode. In addition, the display apparatus 200 may enter (D) the normal display mode in response to a remote-controller input, a user gesture, a voice command, etc.

In (D) the normal display mode, a user operates the display block 255 of FIG. 2. In (D) the normal display mode, the image sensor block 210 may be used to implement an algorithm for determining the identity of a user or an algorithm for tracking a user.

(AB.1) and (AB.2) show switching between (A) the first standby mode and (B) the quasi-standby mode, and may be implemented in response to a remote-controller input. (AC.1) and (AC.2) show switching between (A) the first standby mode and (C) the informative display mode, and may be implemented in response to a remote-controller input regardless of the presence of a user. (AD.1) and (AD.2) show switching between (A) the first standby mode and (D) the normal display mode, and may be implemented in response to a remote-controller input, a gesture, a voice command, etc.

(BC.1) and (BC.2) show switching between (B) the quasi-standby mode and (C) the informative display mode, in which the sensing trigger signal 240 of FIG. 2 corresponding to detection of motion within an image of the view area 205 photographed by the VIS 211 or detection of the presence of a user is transmitted to the display controller 250 of the display block 255 so that (B) the quasi-standby mode can be switched into (C) the informative display mode. In addition, if it is detected that a user moves from the view area 205, the display/audio output section 280 becomes inactivated after a preset period of time, and (C) the informative display mode is switched into (B) the quasi-standby mode.

(BD.1) and (BD.2) show switching between (B) the quasi-standby mode and (D) the normal display mode, in which (B) the quasi-standby mode may be switched into (D) the normal display mode in response to a remote-controller input, a gesture, a voice command, etc. before detecting the presence of a user. In addition, the display may be turned off in response to a remote-controller input, a gesture, a voice command, etc. so that (D) the normal display mode can be switched into (B) the quasi-standby mode. Further, the display apparatus 200 may be set not to enter (C) the informative display mode even though a user is detected.

(CD.1) and (CD.2) show switching between (C) the informative display mode and (D) the normal display mode, in which the display becomes activated in response to a remote-controller input, a gesture, a voice command, etc. so that (C) the informative display mode can be switched into (D) the normal display mode. In addition, the display may be turned off in response to a remote-controller input, a gesture, a voice command, etc. so that (D) the normal display mode can be switched into (C) the informative display mode. Further, the display apparatus 200 may be set not to enter (B) the quasi-standby mode.

FIG. 4 is a view showing an example of switching from a quasi-standby mode to an informative display mode when a user is sensed, according to an exemplary embodiment. As shown in FIG. 4, under (B) the quasi-standby mode, an image photographed by the image sensor is received at operation S410. In this mode, the image sensor may process an image to have a lower resolution than the resolution in the normal mode. According to another exemplary embodiment, the image sensor may process a photographed image at a low frame rate, for example, 1 to 10 frames per second (fps) in order to sense motion of a user within the photographed image. Thus, the image sensor has an effect on consuming the minimum power to detect motion of a user.

Next, at operation S420, motion is sensed based on a difference in brightness of pixels between frames of an image. According to an exemplary embodiment, a method of adding absolute values of brightness difference of all pixels or a method of adding absolute values of brightness difference of pixels in units of columns may be employed in order to compare pixels of two different frames with respect to brightness levels. In the case of using the pixels in units of columns, it is taken into account that a human has a feature of a vertically long silhouette, thereby more efficiently detecting a user and excluding influence of change in brightness of partial pixels, caused by ambient light, background brightness, temperature, background color, etc.

Next, at operation S430, it is determined whether a difference in the brightness of pixels between frames of an image is equal to or greater than a predetermined value. According to an exemplary embodiment, if a sum of absolute differences in brightness of pixels in units of column is equal to or greater than a predetermined value, it is determined that there is motion in the front view area. According to another exemplary embodiment, if an absolute difference in brightness of the respective pixels is equal to or greater than a predetermined value, it is determined as ‘1’, and if the absolute difference is lower than the predetermined value, it is determined as ‘0’. The number ‘1’ is added in units of columns and used in determining the motion.

According to still another exemplary embodiment, a predetermined value used as a reference may be adjusted by analyzing change in a background noise level with respect to time of image frames which have no motion.

Next, at operation S440, a processing target area where motion is detected is determined based on a difference in brightness of pixels between frames of an image. At operation S450, it is determined whether a user is present within the processing target area. At this time, various algorithms for extracting a silhouette, a face, an entire body area, etc. may be used to determine whether a user is present.

At operation S460, the sensing trigger signal is generated. For example, as shown in FIG. 2, at a point of time when the image sensor block 210 determines there is motion and whether a user is present, the sensor controller 230 generates the sensing trigger signal 240 and transmits it to the display controller 250 so that the display block 255 can operate. Lastly, at operation S470, if the motion is determined based on the sensing trigger signal, the display apparatus 200 enters (C) the informative display mode.

FIG. 5 is a view showing an example of switching from the informative display mode to the quasi-standby mode when it is sensed that a user moves from a front view area of the display apparatus, according to an exemplary embodiment. As shown in FIG. 5, in (C) the informative display mode, at operation S510, an image photographed by the image sensor is received. Next, at operation S520, a user's motion is detected and it is determined whether the processing target area is updated. When a user's motion is detected and the processing target area is updated, a user's motion is continuously tracked at operation S530, and it is determined that a user initiates a motion within the view area at operation S533. At this time, if there is no motion of a user within the view area, it is determined at operation S535 whether a user's motion is present within the view area for a preset period of time. If it is determined that there is no motion, at operation S560 the display apparatus enters (B) the quasi-standby mode.

According to another exemplary embodiment, in operation S520, if a user's motion is sensed but the processing target area is not updated, at operation S540 the last determined processing target area is scanned to determine the presence of a user. At this time, if it is determined that a user is not present within the processing target area, at operation S545 an image of the view area is scanned a preset number of times to determine the presence of the user. If a user is not present, at operation S560 the display apparatus enters (B) the quasi-standby mode.

According to an exemplary embodiment, if a user's voice is detected through the MIC (Microphone) even though a user is not detected within a photographed image of the view area, the operational mode may be set to maintain (C) the informative display mode.

According to another exemplary embodiment, if a user is not detected within an image of the view area and a user's voice having a preset level or higher is not sensed, the display apparatus may enter (B) the quasi-standby mode.

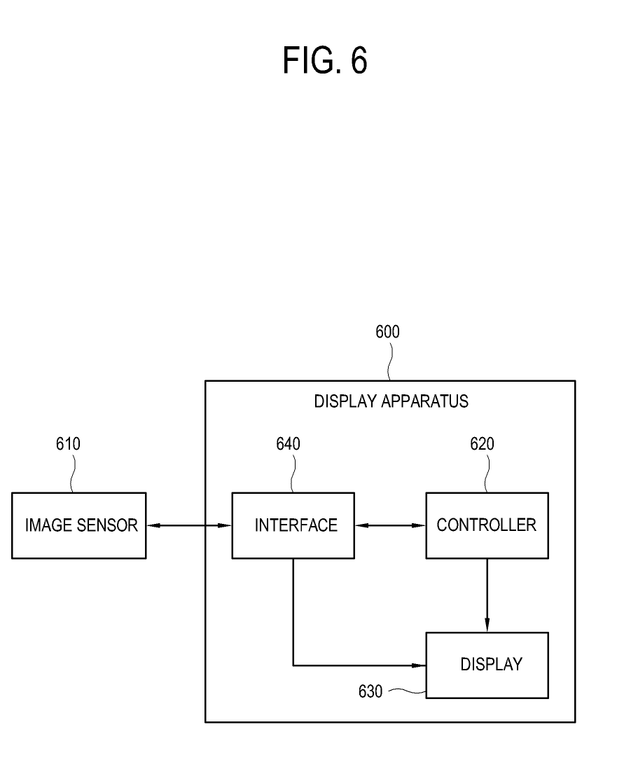

FIG. 6 is a block diagram showing a display apparatus with a detachable image sensor, according to an exemplary embodiment. As shown in FIG. 6, the display apparatus 600 includes a controller 620, a display 630 and an interface 640, and an image sensor 610 is connected to the interface 640. The controller 620 and the display 630 are the same as the controller 120 and the display 130 of FIG. 1, and thus repetitive descriptions thereof will be avoided as necessary. For example, the display apparatus 600 may be achieved by a TV, but is not limited thereto.

The image sensor 610 is detachably connected to the display apparatus 600, and may for example be connected to the display apparatus 600 through a USB cable. However, the image sensor may also be connected in a wireless manner to the display apparatus 600. The image sensor 610 outputs an image captured by photographing a front view area of the display apparatus 600. The image sensor 610 has an optical structure of lenses, and may for example be achieved by a complementary metal oxide semiconductor (CMOS) image sensor (CIS), a charge-coupled device (CCD) image sensor, a heat detector, etc. Alternatively, the image sensor 610 may be achieved by a depth camera, or may be combined with an infrared (IR) source. The image sensor 610 may operate with respect to the whole pixels or a predetermined number of pixels in accordance with the present conditions.

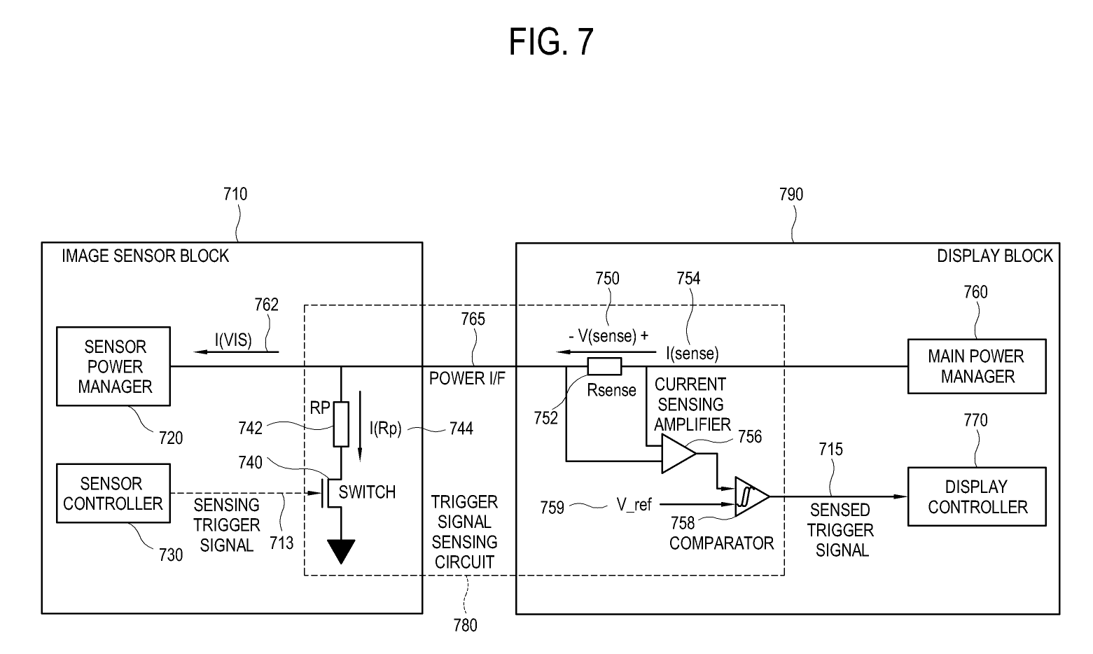

The interface 640 is detachably connected to the image sensor 610, and receives an image captured by photographing a front view area of the display apparatus 600 from the image sensor 610. The interface 640 outputs a sensing signal for transmitting the image taken by the image sensor 610, and at this time the controller 620 performs control so that the photographed image can be received corresponding to the sensing signal output from the interface 640. For example, the interface 640 may be achieved by a USB cable for connecting the image sensor 610 and the display apparatus 600 or by a power supplying line included in the USB cable. As a specific exemplary embodiment of FIG. 6, elements of FIG. 7 will be described.

FIG. 7 is a view showing an example of a circuit for transmitting a sensing trigger signal from the image sensor to the display apparatus through a power interface according to an exemplary embodiment. As shown in FIG. 7, an image sensor block 710 corresponds to a portion of the controller 620 and the image sensor 610 of FIG. 6, and a display block 790 corresponds to a portion of the display 630 and the controller 620 of FIG. 6. A power I/F 765 corresponds to the interface 640 of FIG. 6. The image sensor block 710 and the display block 790 are the same as those of FIG. 2, and thus repetitive descriptions thereof will be avoided.

A trigger signal sensing circuit 780 transmits a sensing trigger signal 713 corresponding to sensed motion or sensed presence of a user output from a sensor collector 730 of the image sensor block 710 to the display block 790 through the power I/F 765 without any separate signal line. The power I/F 765 refers to an interface for supplying power to the display block 790 and the image sensor block 710, and may be for example achieved by a power supplying line of a USB cable for connecting a separate image sensor to the display apparatus.

The trigger signal sensing circuit 780 includes a switch 740, a resistor (Rp) 742, a resistor (Rsense) 752, a current sensing amplifier 756, a comparator 758. The trigger signal sensing circuit 780 turns off the switch 740 if the sensing trigger signal 713 corresponding to sensed motion or sensed presence of a user is not generated, thereby preventing the current I (Rp) 744 from flowing through the resistor (Rp) 742. Further, the trigger signal sensing circuit 780 turns on the switch 740 if the sensing trigger signal 713 corresponding to sensed motion or sensed presence of a user is generated, thereby making the current I (Rp) 744 flow through the resistor (Rp) 742. With this operation, the trigger signal sensing circuit 780 causes difference in voltage between both ends of the resistor (Rsense) 752 by the current I (Rp) varied depending on the ON-OFF operations of the switch.

The current sensing amplifier 756 amplifies the difference in voltage generated between both ends of the resistor (Rsense) 752, and the comparator 758 compares the voltage difference amplified in the current sensing amplifier 756 with a preset comparison value (V_ref) 759 and inputs a sensed trigger signal 715 to the display controller 770.

According to an exemplary embodiment, if the image sensor is not integrated into the display apparatus but is provided as a separate external device, not only the image output from the image sensor but also the sensing trigger signal corresponding to the sensed presence of the user output from the image sensor can be transmitted through the power supplying line of the USB cable for connecting the image sensor.

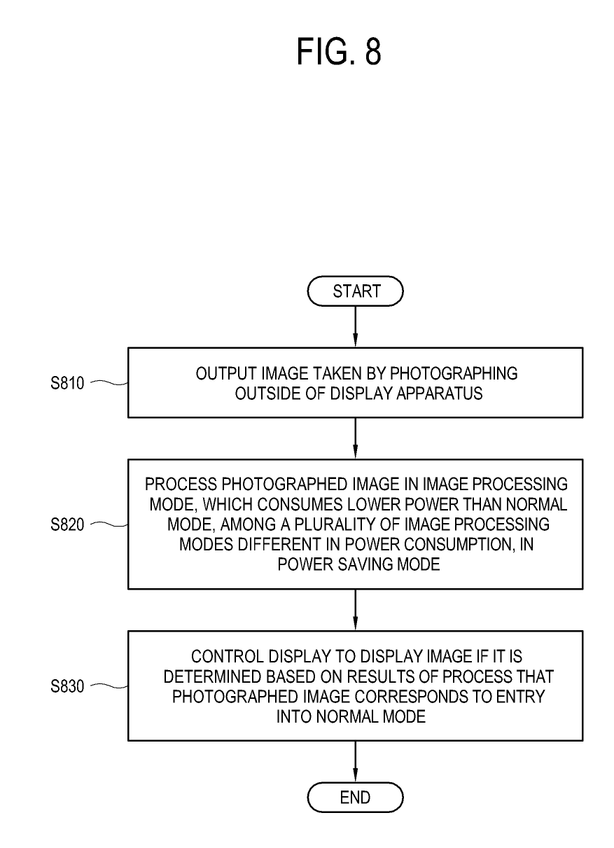

FIG. 8 is a flowchart showing a control method of a display apparatus according to an exemplary embodiment. As shown in FIG. 8, at operation S810, an image captured by photographing a front view area of the display apparatus is output. Next, at operation S820, while the display apparatus is in a power saving mode, a photographed image is processed in an image processing mode, in which the power consumption is lower than the power consumption of a normal image processing mode, among the plurality of image processing modes, each of which has a different level of power consumption. The plurality of image processing modes may be differentiated from each another in at least one among the number of pixels or the frames of an image to be processed, a resolution and an operation frequency.

The operation S820 for processing the photographed image may include an operation for processing a predetermined number of pixels among the whole pixels of the image in the power saving mode, and an operation for processing a predetermined number of frames among the whole frames. Further, the operation S820 may further include an operation for processing an image in the power saving mode to have a resolution lower than a resolution of the image in the normal mode.

According to an exemplary embodiment, the operation S820 may include an operation of determining a processing target area, in which there is motion, among the whole area of the processed image. The processing target area may be determined based on a difference in brightness of the whole pixels between the first and second frames of the image. In addition, the processing target area may be determined based on a difference of pixels in units of a column between the first and second frames of the image.

According to another exemplary embodiment, the presence of a user within the processing target area may be determined based on the shape of the processing target area.

Lastly, at operation S830, if it is determined based on the processing results that the photographed image indicates the presence of a user, the display is controlled to display an image. For instance, as shown in FIG. 4, in (B) the quasi-standby mode, the processing target area corresponding to a motion is determined based on a difference in brightness of pixels between frames of an image photographed by the image sensor (S420, S430, and S440), and it is detected whether a user is present within the processing target area (S450 and S460) so as to enter (C) the informative display mode (S470).

According to another exemplary embodiment, if a user is not present within the processing target area, the power saving mode may begin. For instance, as shown in FIG. 5, in (C) the informative display mode, motion is tracked within the image photographed by the image sensor (S530) and if motion is not detected within a preset period of time (S535), (B) the quasi-standby mode may begin (S560). Further, the processing target area is scanned (S540) and if the presence of a user is not detected within a preset number of scanning attempts (S545), (B) the quasi-standby mode may begin (S560).

As described above, in the display apparatus according to an exemplary embodiment, in the power saving mode, an image photographed by the image sensor is processed in an image processing mode, in which power consumption is lower than the power consumption of the normal mode, and if it is determined based on the processing results that the photographed image indicates the presence of a user, the display displays an image, thereby having an effect on minimizing power consumption when a user is not detected by the image sensor.

Further, in the display apparatus according to an exemplary embodiment, the presence of a user is sensed if the user remains motionless while positioned in front of the display apparatus, or if the user leaves the front view area of the display apparatus after being sensed by the image sensor.

Although a few exemplary embodiments have been shown and described, it will be appreciated by those skilled in the art that changes may be made in these exemplary embodiments without departing from the principles and spirit of the inventive concept, the scope of which is defined in the appended claims and their equivalents.

What is claimed is:

1. A display apparatus comprising:
a display configured to display an image;
an image sensor configured to photograph an image of a front view area of the display apparatus; and
a controller having a plurality of image processing modes, each image processing mode of the plurality of image processing modes having a power consumption level that is different than a power consumption level of other image processing modes of the plurality of image processing modes, the controller being configured to, in a power saving mode, process the photographed image in an image processing mode, which consumes less power than a normal mode, among the plurality of image processing modes, and in response to determining, based on a result of the processing the photographed image, that the photographed image indicates a presence of a user in the front view area of the display apparatus, control the display to display the image in the normal mode.

2. The display apparatus according to claim 1, wherein the plurality of image processing modes are different from each other in at least one of a number of pixels of the photographed image to be processed or frames of the photographed image to be processed, a resolution of the photographed image, and an operation frequency.

3. The display apparatus according to claim 2, wherein the controller is configured to process some pixels among all pixels of the photographed image in the power saving mode.

4. The display apparatus according to claim 2, wherein the controller is configured to process some frames among all frames of the photographed image in the power saving mode.

5. The display apparatus according to claim 2, wherein the controller is configured to, in the power saving mode, process the photographed image to have a resolution that is lower than a resolution of the normal mode.

6. The display apparatus according to claim 1, wherein the controller is configured to determine a processing target area, in which there is motion, among a whole area of the photographed image to be processed.

7. The display apparatus according to claim 6, wherein the controller is configured to determine the processing target area based on a difference in brightness of pixels between a first frame and a second frame of the photographed image.

8. The display apparatus according to claim 6, wherein the controller is configured to determine the processing target area based on a difference in brightness of pixels in units of columns between a first frame and a second frame of the photographed image.

9. The display apparatus according to claim 6, wherein the controller is configured to determine whether the user is present within the processing target area, based on shapes of the processing target area.

10. The display apparatus according to claim 9, wherein the controller enters the power saving mode in response to determining the user is not present within the processing target area.

11. A display apparatus comprising:
a display configured to display an image;
an interface configured to connect with a detachable image sensor, and receive from the image sensor a photographed image of a front view area of the display apparatus; and
a controller having a plurality of image processing modes, each image processing mode of the plurality of image processing modes having a power consumption level that is different than a power consumption level of other image processing modes of the plurality of image processing modes, the controller being configured to, in a power saving mode, process the photographed image in a image processing mode, which consumes less power than a normal mode, among the plurality of image processing modes, and in response to determining, based on a result of the processing the photographed image, that the photographed image indicates a presence of a user in the front view area of the display apparatus, control the display to display the image in the normal mode.

12. The display apparatus according to claim 11, wherein the interface is configured to output a sensing signal for transmitting an image photographed by the image sensor, and
the controller is configured to perform control to receive the photographed image in response to the sensing signal output from the interface.

13. A method of controlling a display apparatus, the method comprising:
outputting a photographed image of a front view area of the display apparatus;
in a power saving mode, processing the photographed image in a image processing mode, which consumes less power than a normal mode, among a plurality of image processing modes, each image processing mode of the plurality of image processing modes having a power consumption level that is different than a power consumption level of other image processing modes of the plurality of image processing modes; and
controlling the display to display an image in the normal mode in response to determining, based on a result of the processing the photographed image, that the photographed image indicates a presence of a user in the front view area of the display apparatus.

14. The method according to claim 13, wherein the plurality of image processing modes are different from each other in at least one of a number of pixels or frames of the image to be processed, a resolution and an operation frequency.

15. The method according to claim 14, wherein the processing the photographed image comprises processing some pixels among all pixels of the image in the power saving mode.

16. The method according to claim 14, wherein the processing the photographed image comprises processing some frames among all frames of the image in the power saving mode.

17. The method according to claim 14, wherein the processing the photographed image comprises processing an image in the power saving mode to have a resolution that is lower than a resolution of the normal mode.

18. The method according to claim 13, wherein the processing the photographed image comprises determining a processing target area, in which there is motion, among a whole area of the processed photographed image.

19. The method according to claim 18, further comprising determining the processing target area based on a difference in brightness of whole pixels between a first frame and a second frame of the photographed image.

20. The method according to claim 18, further comprising determining the processing target area based on a difference in brightness of pixels in units of columns between a first frame and a second frame of the photographed image.

21. The method according to claim 18, further comprising determining whether a user is present within the processing target area, based on shapes of the processing target area.

22. The method according to claim 21, further comprising entering the power saving mode in response to determining a user is not present within the processing target area.
